(19) United States
(12) Patent Application Publication
(10) Pub. No.: US 2010/0163593 A1
(43) Pub. Date: Jul. 1, 2010

(54) OPTICAL FIBER CLEAVER

(76) Inventors: Jae Seop Song, Daejeon (KR); Sang Chul Jun, Chungcheongbuk-do (KR); Young Bae Seo, Chungcheongbuk-do (KR)

Correspondence Address: BERLINER & ASSOCIATES, 555 WEST FIFTH STREET, 31ST FLOOR, LOS ANGELES, CA, 90013, US

(21) Appl. No.: 12/447,229

(22) PCT Filed: Jun. 4, 2007
(86) PCT No.: PCT/KR07/02695

§ 371 Date: Mar. 8, 2010

(30) Foreign Application Priority Data
Oct. 26, 2006 (KR) 10 2006 0104395
Feb. 2, 2007 (KR) 10 2007 0010964
Mar. 12, 2007 (KR) 10 2007 0023820
Apr. 19, 2007 (KR) 10 2007 0038112

(51) Int. Cl. G02B 6/25

(52) U.S. Cl. 225/96

(57) ABSTRACT

An optical fiber cleaver is disclosed. The optical fiber cleaver of the present invention includes a cleaving unit (1), which cleaves an optical fiber (F), and a twisting unit (2), which is disposed opposite the cleaving unit (1). The cleaving unit (1) includes a main body (3), first and second covers (9) and (11), which are pivotably provided on the main body (3), and a slider (7), which is provided in an end of the main body (3) so as to be movable across a base (5). The twisting unit (2) is provided opposite the main body (3) and includes a stand (4), which is movable on the upper surface of the base (5), a rotating body (6), which is rotatably provided on the stand (4), and a clamp (8), which is provided on an end of the rotating body (6).

### TECHNICAL FIELD

The present invention relates to an optical fiber cleaver for cleaving optical fibers.

### BACKGROUND ART

As well known to those skilled in the art, optical fibers are fiber waveguides for transmitting data using light. Typically, the optical fibers are used in the form of an optical cable, in which several strands are combined into a bundle.

An optical fiber cleaver for cleaving such an optical fiber includes two covers, which clamp two portions of the optical fiber, and a slider, which is provided with a blade for scoring the lower surface of the optical fiber. The optical fiber cleaver is constructed such that the blade can score the optical fiber without vibrating.

In the process of cleaving the optical fiber, if the optical fiber is precisely cleaved in a direction perpendicular to the axis thereof, thus forming a perpendicular cross-section, there is no problem. However, in reality, an optical fiber is frequently cleaved, such that the cross-section thereof is inclined at an angle. In this case, there is a problem in that the inclined cross-section may act as a reflective surface with respect to light that passes through a junction between optical fibers, thus causing light loss.

In an effort to overcome the above-mentioned problem, a method of cleaving an optical fiber after twisting it in a figure-8-shape to prevent the loss of a reflective surface was proposed in U.S. Pat. No. 5,048,908. In this technique, the optical fiber is cleaved in a state in which tensioning force and torque are applied to the optical fiber, so that the cleaved cross-section of the optical fiber has a twisted figure-8-shape.

Meanwhile, the applicant of the present invention proposed an optical fiber cleaver in Korean Patent Application No. 10-2004-0017563 (title: OPTICAL FIBER CLEAVER HAVING TENSIONING AND TWISTING FUCTIONS). In this technique, an optical fiber is cleaved in a state in which tensioning force and torque are applied to the optical fiber. Therefore, the cleaved cross-section of the optical fiber can have a shape perpendicular to the axis of the optical fiber, or a twisted figure-8-shape.

However, in this technique, proposed by the applicant of the present invention, after the optical fiber is clamped by a cleaving unit and a twisting unit, tensioning force is applied to the clamped optical fiber by moving the twisting unit, and twisting force is applied to the optical fiber by rotating a rotating body of the twisting unit. Thereafter, the optical fiber is cleaved by closing the cover of the cleaving unit. Subsequently, the cover of the cleaving unit is opened, and the twisting unit is manually returned to its original position. Therefore, there is a disadvantage in that the manipulation of the optical fiber cleaver is very inconvenient.

Furthermore, the conventional technique proposed by the present applicant has a disadvantage in that the optical fiber is not reliably clamped, so that the cleaved cross-section thereof is not accurate.

Meanwhile, of typical optical fiber cleavers, there is an optical fiber cleaver having a linear blade. The optical fiber cleaver having the linear blade has advantages in that the size and weight thereof are small, compared to those of an optical fiber cleaver having a circular blade, so that it is easy to carry. However, the optical fiber cleaver having the linear blade is disadvantageous in that a cleaved cross-section is not accurate, compared to that of the optical fiber cleaver having the circular blade, and the lifetime of the linear blade is shorter than that of the circular blade.

### DISCLOSURE OF INVENTION

### Technical Problem

Accordingly, the present invention has been made keeping in mind the above problems occurring in the prior art, and an object of the present invention is to provide an optical fiber cleaver, which is constructed such that an optical fiber is cleaved in a state in which tensioning force and torque are applied to the optical fiber, so that the cleaved cross-section of the optical fiber can have a shape perpendicular to the axis of the optical fiber, or a twisted figure-8-shape.

Another object of the present invention is to provide an optical fiber cleaver which makes it convenient to conduct the operation of cleaving the optical fiber.

A further object of the present invention is to provide an optical fiber cleaver which is constructed such that the optical fiber can be reliably clamped, thus making the cleaved cross-section of the optical fiber more accurate.

Yet another object of the present invention is to provide an optical fiber cleaver which can reliably score the optical fiber without applying a shock thereto, thus cleaving the optical fiber more accurately.

Still another object of the present invention is to provide an optical fiber cleaver which can extend the lifetime of a blade for scoring the optical fiber.

### Technical Solution

In order to accomplish the above objects, an optical fiber cleaver according to an embodiment of the present invention includes: a cleaving unit, which has first and second covers that are openably provided on a main body, and a striking member provided in the first cover; and a twisting unit, which is disposed opposite the cleaving unit and a rotating body, which is rotated by an opening and closing operation of the first cover, wherein the first and second covers are pivoted together.

The first cover may include a drive lever, which is removably coupled at a predetermined position to the first cover. The drive lever may be provided so that it can be brought into contact with and separated from the rotating body of the twisting unit.

The twisting unit may further include a returning spring, which returns the rotating body to its original position when the first cover is opened.

The optical fiber cleaver may further include a tension unit which moves the twisting unit in a direction toward or away from the cleaving unit.

The tension unit may include a pair of magnets which are provided in surfaces of the twisting unit and the cleaving unit that face each other. The magnets may be oriented such that different poles thereof alternate with each other.

The cleaving unit may further include a slider, which moves in response to the opening or closing of the first cover. The slider may have a blade for scoring the optical fiber.

The striking member and the slider may have magnets on portions thereof which are adjacent to each other, such that like poles of the magnets face each other.

Furthermore, a clamping block may be provided between the first cover and the main body. The clamping block may be elastically supported by an elastic member.

The twisting unit may have a clamp, which is provided on an end of the rotating body to clamp the optical fiber.

An optical fiber cleaver according to another embodiment of the present invention includes a main body, and a cover, which is pivotably provided on the main body. The cover has a linear blade, which is movable in a direction perpendicular to the axis of the clamped optical fiber.

An optical fiber cleaver according to a further embodiment of the present invention includes a main body, a cover, which is pivotably provided on the main body, and a slider, which is movable with respect to the main body. The slider has a blade, and a damper is provided between the slider and the main body.

The damper may have a pinion, and the slider may have a rack, so that the damping force of the damper is transmitted to the slider through the engagement between the pinion and the rack.

### Advantageous Effects

In the optical fiber cleaver according to the present invention, an optical fiber is cleaved in a state in which tensioning force and torque are applied to the optical fiber, so that the cleaved cross-section of the optical fiber can have a shape perpendicular to the axis of the optical fiber or a twisted figure-8-shape.

Furthermore, the optical fiber cleaver of the present invention makes it convenient to conduct the operation of cleaving the optical fiber.

In addition, in the present invention, because the optical fiber can be reliably clamped, the cleaved cross-section of the optical fiber can be formed more accurately.

As well, the optical fiber cleaver can reliably score the optical fiber without applying a shock thereto, thus cleaving the optical fiber more accurately.

Moreover, the optical fiber cleaver can extend the lifetime of a blade for scoring the optical fiber.

### BRIEF DESCRIPTION OF THE DRAWINGS

FIG. 1 is a perspective view of an optical fiber cleaver, according to a first embodiment of the present invention;

FIG. 2 is a side view illustrating first and second covers of a cleaving unit according to the present invention;

FIG. 3 is a side view illustrating a slider according to the present invention;

FIG. 4 is a partial sectional view illustrating the first cover according to the present invention;

FIG. 5 is a partial sectional view along the arrow A of FIG. 1;

FIG. 6 is a view along the arrow B of FIG. 5;

FIG. 7 is an exploded perspective view illustrating a main body and the slider according to the present invention;

FIG. 8 is a side sectional view of an optical fiber cleaver, according to a second embodiment of the present invention;

FIG. 9 is a sectional view taken along the line E-E of FIG. 8;

FIG. 10 is a sectional view taken along the line F-F of FIG. 8;

FIG. 11 is a view showing a linear blade and an optical fiber according to the second embodiment of the present invention;

FIG. 12 is views illustrating a process of cleaving the optical fiber according to the second embodiment of the present invention;

FIG. 13 is a perspective sectional view of a cleaving unit of an optical fiber cleaver, according to a third embodiment of the present invention;

FIG. 14 is an exploded perspective view showing the cleaving unit according to the third embodiment of the present invention;

FIG. 15 is a side sectional view showing an open state of a first cover according to the third embodiment of the present invention;

FIG. 16 is a side sectional view showing a closed state of the first cover according to the third embodiment of the present invention;

FIG. 17 is a plan sectional view taken along the line C-C of FIG. 3 or 16;

FIG. 18 is a rear view showing a damper according to the third embodiment of the present invention;

FIG. 19 is a view illustrating a process of cleaving optical fibers using a striking member according to the third embodiment of the present invention;

FIG. 20 is a front view of an ultrasonic optical fiber cleaver, according to a fourth embodiment of the present invention;

FIG. 21 is a plan view of the ultrasonic optical fiber cleaver according to the fourth embodiment of the present invention;

FIG. 22 is a sectional view taken along the line D-D of FIG. 21;

FIG. 23 is a side view showing the ultrasonic optical fiber cleaver according to the fourth embodiment of the present invention;

FIG. 24 is a view showing a slider and a damper according to the fourth embodiment of the present invention;

FIG. 25 is a view seen along the arrow G of FIG. 24; and

FIG. 26 is a sectional view showing a modification of the blade according to the present invention.

### BEST MODE FOR CARRYING OUT THE INVENTION

Hereinafter, preferred embodiments of the present invention will be described in detail with reference to the attached drawings.

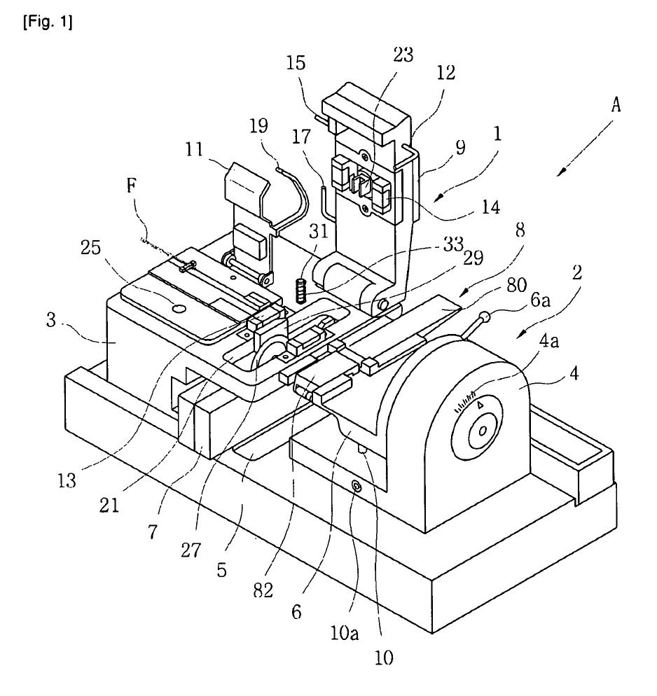

Referring to FIG. 1, an optical fiber cleaver according to the first embodiment of the present invention includes a cleaving unit 1, which cleaves an optical fiber F, and a twisting unit 2, which is provided opposite the cleaving unit 1.

The cleaving unit 1 includes a main body 3, first and second covers 9 and 11, which are pivotably mounted on the main body 3, and a slider 7, which is provided in an end of the main body 3 so as to be movable across a base 5.

The main body 3 has a support 13, an opening 21, a magnet 25 and a protruding pin 31 in the upper surface thereof.

The first cover 9 has a striking member 23 and a clamping block 14 on one surface thereof and has a drive lever 12, a pulling pin 15 and a pushing pin 17 on opposite sidewalls thereof.

The second cover 11 has an arc-shaped arm 19 on an edge thereof which is adjacent to the first cover 9. Furthermore, the second cover 11 is made of a magnetic substance, so that, when the second cover 11 is pivoted to close onto the main body 3, the second cover 11 can be maintained in the state in which it is closed on the main body 3 using the magnetic force of a magnet 25 provided in the main body 3.

When the first cover 9 is pivoted to close onto the main body 3, the striking member 23 serves to strike pan of an optical fiber F and thus cleave it.

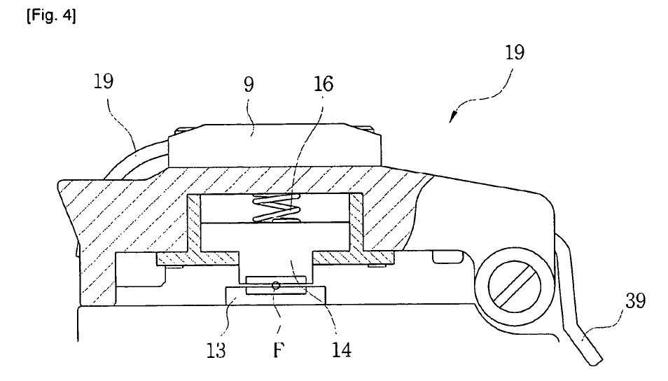

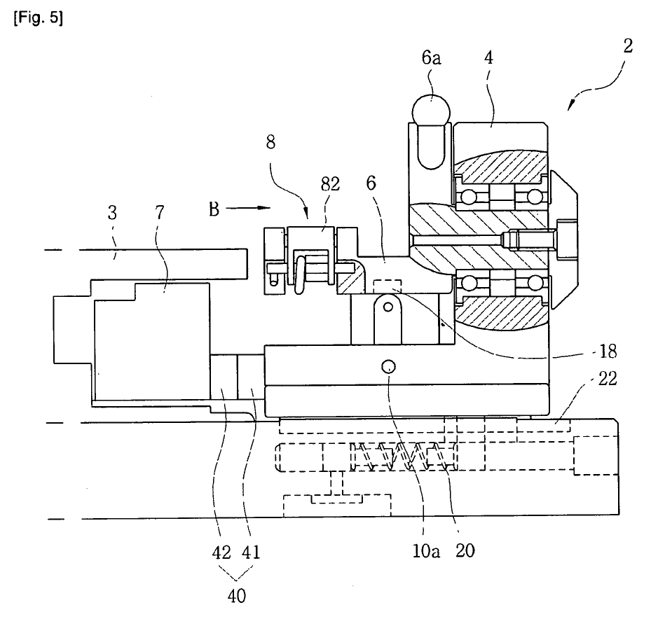

The clamping block 14 serves to clamp the optical fiber F along with a support 13 of the main body 3. In detail, as shown in FIG. 4, the clamping block 14 compresses the upper surface of the optical fiber F, and the support 13 supports the lower surface of the optical fiber F, thus clamping the optical fiber F.

The clamping block 14 is elastically supported by an elastic member 16 such as a spring. Thereby, the clamping block 14 and the support 13 more closely contact the optical fiber F, thus clamping the optical fiber F more reliably.

The drive lever 12 is removably mounted to one sidewall of the first cover 9 and serves to push and rotate a rotating body 6 of the twisting unit 2, which will be explained later herein.

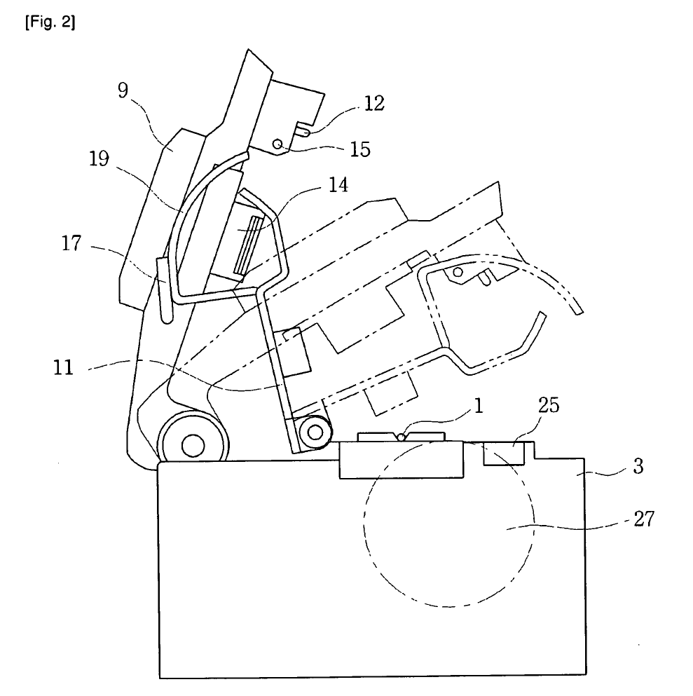

As shown in FIG. 2, when the first cover 9 is opened, the pulling pin 15 contacts and lifts the arm 19 of the second cover 11, so that the second cover 11 is opened along with the first cover 9. When the first cover 9 is closed, the pushing pin 17 pushes the arm 19 of the second cover 11 downwards, so that the second cover 11 is closed along with the first cover 9.

Here, because the pulling pin 15 and the pushing pin 17 are removable, the second cover 11 may be constructed such that it is operated separately.

The slider 7 includes a blade 27, which scores part of the optical fiber F to be cleaved, and a stop protrusion 29. The blade 27 is partially exposed through the opening 21 of the main body 3. The stop protrusion 29 is guided in the opening 21 to restrict the distance that the slider 7 is moved.

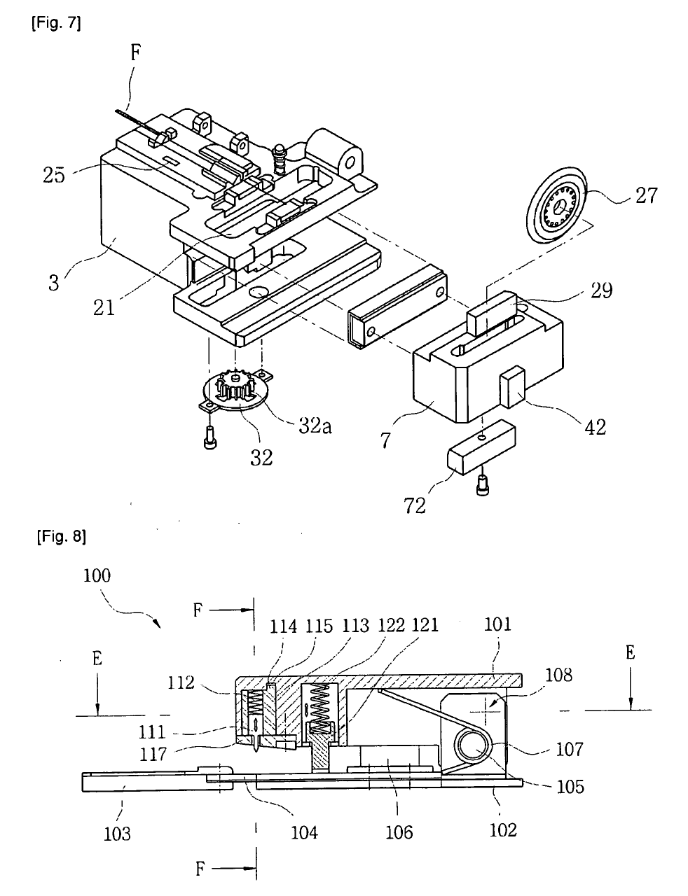

As shown in FIGS. 1 through 3 and 7, the blade 27 may have a circular shape. Alternatively, as shown in FIGS. 8, 10 and 11, the blade 27 may have a linear shape.

Meanwhile, first and second stoppers 31 and 35, which control movement of the slider 7, are respectively provided in a portion of the main body 3 and a portion of the slider 7 which are adjacent to each other. The first stopper 31 is elastically supported upwards by a spring 33. Correspondingly, the second stopper 35 is elastically supported upwards by a spring 38. The lower end 31a of the first stopper 31 is in contact with the upper end 35a of the second stopper 35. Furthermore, the lower end 31a of the first stopper 31 is moved in a hole 39, which is formed in the main body 3, and the upper end 35a of the second stopper 35 is removably inserted into the hole 39 of the main body 3. Therefore, when the first cover 9 is opened, the upper end 35a of the second stopper 35 is inserted into the hole 39, so that the movement of the slider 7 is stopped. When the second cover 9 is closed, the lower end 31a of the first stopper 31 pushes the upper end 35a of the second stopper 35, so that the upper end 35a of the second stopper 35 is removed from the hole 39, and the slider 7 thus enters a movable state.

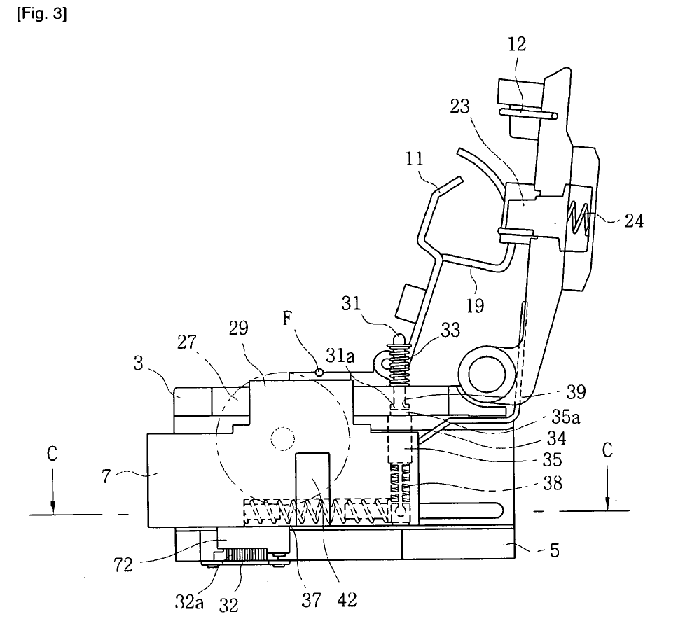

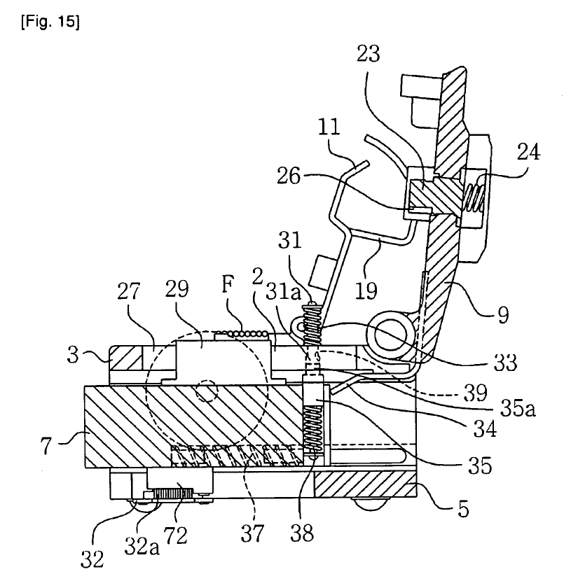

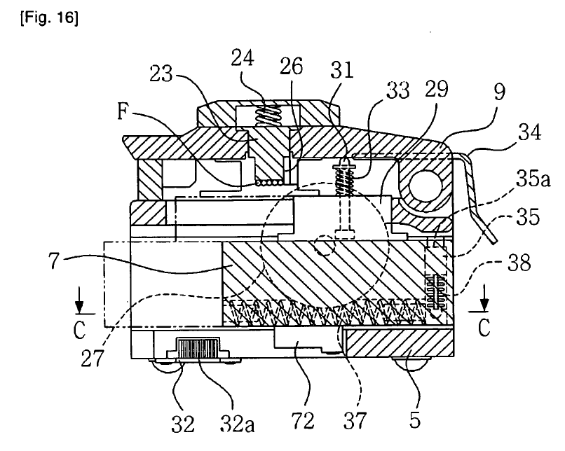

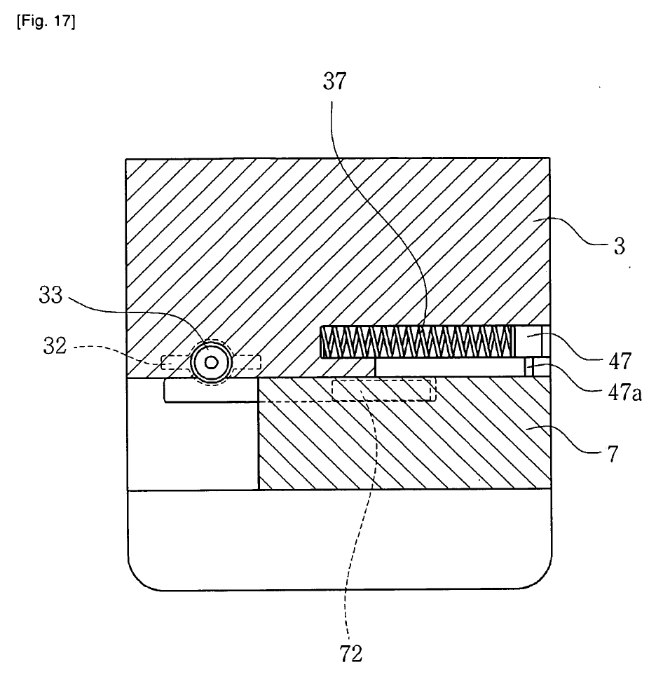

As shown in FIGS. 3, 15 and 16, the slider 7 is biased in one direction by a biasing member 37 such as a spring. As shown in FIG. 17, the biasing member 37 is installed in the main body 3. A seat body 47, to which the biasing force of the biasing member 37 is applied, is provided on the end of the seat body 47. The seat body 47 is connected to the slider 7 by a connection pin 47a. Therefore, when the upper end 35a of the second stopper 35 is removed from the hole 39 of the main body 3, the slider 7 is moved in one direction by the biasing force of the biasing member 37. At this time, the blade 27 scores the optical fiber F due to the movement of the slider 7. In other words, when the first cover 9 is closed onto the main body 3, the slider 7 is moved by the biasing force of the biasing member 37, and thereby the blade 27 scores the optical fiber F.

In addition, a compressing member 34 is provided on the lower end of the first cover 9. When the first cover 9 is opened, the compressing member 34 compresses the slider 7 and moves it to its original position. When the slider 7 is moved to its original position, the upper end 35a of the second stopper 35 is inserted into the hole 39 of the main body 3 again, thus stopping the movement of the slider 7.

The twisting unit 2 is disposed at a predetermined position opposite the main body 3 and includes a stand 4, which is movably provided on the upper surface of the base 5, the rotating body 6, which is rotatably provided on the stand 4, and a clamp 8, which is provided on an end of the rotating body 6.

The stand 4 has a stopper 10, which is made of a magnetic substance and restricts the range within which the rotating body 6 can rotate. The stopper 10 is provided so as to be vertically movable and can be fixed at a desired position using a set screw or the like.

The rotating body 6 is rotatably supported on the stand 4 using a shaft and a bearing. The rotating body 6 is provided so that it can be rotated by the pushing operation of the drive lever 12. Furthermore, two magnets (not shown) are provided in respective portions of the drive lever 12 and the rotating body 6, which are adjacent to each other. The two magnets are oriented such that like poles face each other, so that the rotating body 6 can be rotated using repulsive force between the two magnets, like poles of which face each other.

Furthermore, the rotating body 6 can also be manually rotated using a handle 6a, which is provided on the end of the rotating body 6.

The rotating body 6 has a magnet 18 at a position facing the stopper 10. The magnet 18 and the stopper 10, which is made of the magnetic substance, attract each other using magnetic force. Therefore, the stopper 10 can be vertically moved by rotation of the rotating body 6. Thus, the range within which the rotating body 6 is rotated can be adjusted by changing and fixing the vertical position of the stopper 10 using the set screw 10a. Furthermore, the rotation range of the rotating body 6 can be indicated through a scale 4a marked on the stand 4.

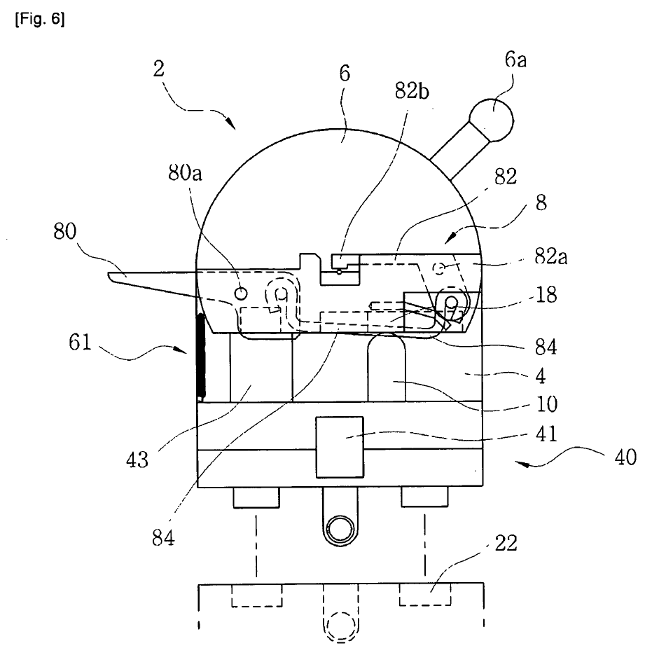

As shown in FIG. 6, the clamp 8 includes a lever 80 and a compressing member 82, which are individually and rotatably provided on the end of the rotating body 6, and a link 84, respective opposite ends of which are coupled to the lever 80 and the compressing member 82.

The lever 80 is rotatably mounted to the end of the rotating body 6 using a hinge pin 80a. The compressing member 82 is rotatably mounted to the end of the rotating body 6 using a hinge pin 82a at a position spaced apart from the lever 80 by a predetermined distance. The opposite ends of the link 84 are individually coupled to respective ends of the lever 80 and the compressing member 82, which face each other. Thus, when the lever 80 is rotated in one direction, the rotating force thereof is transmitted to the compressing member 82 through the link 84 in the same direction. Therefore, the compressing member 82 is rotated in the same direction as the lever 80. Particularly, when one end 82b of the compressing member 82 is rotated towards the rotating body 6, the end 82b of the compressing member 82 pushes the upper part of the optical fiber F, thus clamping the optical fiber F.

Meanwhile, the present invention may further include a tensioning unit 40, which is provided between the cleaving unit 1 and the twisting unit 2 to apply tension to the clamped optical fiber F. The tension unit 40 includes a pair of magnets 41 and 42, which are respectively provided in surfaces of the slider 7 and the stand 4, which face each other.

The magnets 41 and 42 are oriented such that two poles (the N pole and the S pole) of the magnet 41 face two poles (the N pole and the S pole) of the magnet 42. Thus, the stand 4 can be moved using magnetic force, that is, attractive force or repulsive force, generated between the magnets 41 and 42. In detail, when the first cover 9 is opened, the magnets 41 and 42 are disposed such that attractive force is generated between the magnets 41 and 42, so that the stand 4 is moved in a direction toward the main body 3. When the first cover 9 is closed so that the slider 7 is moved, the magnets 41 and 42 are disposed such that repulsive force is generated between the magnets 41 and 42, thereby the stand 4 is moved in a direction away from the main body 3.

Alternatively, the tension unit may have a structure in which the magnets 41 and 42 may be oriented such that like poles thereof face each other and a spring 20 that moves the stand 4 in the direction toward the main body 3 is provided in the lower end of the stand 4. In this case, repulsive force generated between the magnets 41 and 42 is applied between the stand 4 and the main body 3, so that the stand 4 can be moved in the direction away from the main body 3 by the repulsive force. Furthermore, the stand 4 can be moved in the direction toward the main body 3 by the spring 20. Here, a tension spring that can move the stand 4 towards the main body 3 is used as the spring 20.

As a further alternative, the tension unit may have a structure in which the magnets 41 and 42 may be oriented such that unlike poles thereof face each other, and such that a spring 20, which moves the stand 4 in the direction away from the main body 3, is provided in the lower end of the stand 4. In this case, attractive force generated between the magnets 41 and 42 is applied between the stand 4 and the main body 3, so that the stand 4 can be moved in the direction toward the main body 3 by the attractive force. Furthermore, the stand 4 can be moved in the direction away from the main body 3 by the spring 20. Here, a compression spring, which can move the stand 4 away from the main body 3, is used as the spring 20.

As shown in FIG. 6, a returning spring 61 is provided between the rotating body 6 and the stand 4. When the cover 9 is opened, because the drive lever 12 is moved away from the rotating body 6, the rotating body 6 enters a free state, so that the rotating body 6 is returned to its original position by the elastic force of the returning spring 61.

Furthermore, a support block 43 is provided at a predetermined position under the rotating body 6. The support block 43 serves to support the rotating body 6 to maintain the state in which the rotating body 6 is returned to its original position by the spring. As such, because the rotating body 6 is supported by the support block 43 at its original position, the rotating body 6 is prevented from being undesirably rotated by external force.

Meanwhile, the slider 7 may have a damper 32 at a predetermined position. Various kinds of dampers, for example, a rotary damper, using damping force generated by the viscous resistance of oil, or an oscillating damper, using oil pressure, can be used as the damper. In detail, the damper 32 includes a pinion 32a, and the slider 7 has a rack 72. The damping force of the damper 32 is applied to the slider 7 by engagement between the rack 72 and the pinion 32a. Thereby, the slider 7 can move at a constant speed, so that the scoring operation of the blade 27 can be conducted more accurately.

As such, thanks to the operation of the damper 32, the slider 7 can maintain the speed at which it is moved, so that the blade 27 can score the optical fiber without applying shocks thereto. Therefore, the blade 27 can wear normally rather than wearing by chipping, attributable to shocks, thus markedly extending the lifetime thereof. Furthermore, a diamond, which is not resistant to shock, can be applied to the blade 27, and the blade 27 can be used on a semi-permanent basis without replacement thereof.

In particular, because the blade 27 repeatedly contacts the optical fibers F, the blade 27 has high stiffness, thus preventing abrasion thereof. To respond to this, it is preferable that the blade 27 of the present invention be made of synthetic diamond (poly crystalline diamond).

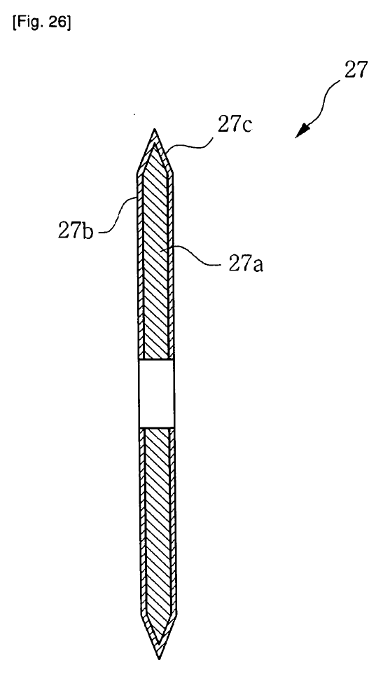

Furthermore, as a method for increasing the lifetime of the blade 27, the blade 27 may comprise a blade body 27a and a reinforcing layer 27b, as shown in FIG. 26.

In this case, the blade body 27a is made of a relatively strong material, such as cemented carbide or steel. In addition, a pointed edge part 27c, which is reduced in width from the inside to the outside, is formed in the circumferential outer edge of the blade body 27a. The blade body 27a generally has an approximately disk shape.

The reinforcing layer 27b is made of diamond, titanium compound or aluminum compound, and is formed on the surface of the blade body 27a through a CVD (Chemical Vapor Deposition) method or a PVD (Physical Vapor Deposition) method.

In this embodiment, although the reinforcing layer 27b has been applied to the entire surface of the blade body 27a, the reinforcing layer 27b may be applied only to the pointed edge part 27c of the blade body 27a, which substantially contacts the optical fiber, so as to reduce the cost of manufacturing the blade.

In this case, because the reinforcing layer 27b is formed only on the pointed edge 27c, which contacts the optical fiber, a required amount of material, such as diamond, which is expensive, can be reduced.

In the above-mentioned description, a technique pertaining to the CVD method for depositing diamonds is well known to those skilled in the art, and a technique pertaining to the PVD method for depositing diamonds is also well known to those in the art, therefore further explanation for the CVD method and the PVD method is deemed unnecessary.

In the optical fiber cleaver according to the first embodiment of the present invention having the above-mentioned construction, part of the optical fiber F is clamped by the clamp 8 and, thereafter, the first cover 9 is closed. At this time, the second cover 11 is also closed along with the first cover 9. Then, the part of the optical fiber F is clamped by the clamp 9, while the remaining part of the optical fiber F is clamped by the first and second covers 9 and 11 at two positions.

Here, when the first cover 9 is closed, the drive lever 12 of the first cover 9 pushes the rotating body 6 of the twisting unit 2, thus rotating the rotating body 6. Thereby, the optical fiber F is twisted. Furthermore, the stand 4 is moved away from the slider 7 by the tension unit 40, so that tensioning force is longitudinally applied to the optical fiber F.

In addition, when the first cover 9 is closed, the lower end 31a of the first stopper 31 pushes the upper end 35a of the second stopper 35, so that the upper end 35a of the second stopper 35 is removed from the hole 39, thus the slider 7 enters the movable state. Simultaneously, the slider 7 is moved in one direction by the biasing member 37, so that the blade 27 of the slider 7 scores the optical fiber F.

At this time, the tensioning force and the twisting force, which are applied to the optical fiber F by the twisting unit 2 and the tension unit 40, act as a source of stress on the optical fiber F. Because the striking force of the striking member 23 is applied in the direction in which the stress is applied, the cut surface of the optical fiber F forms a figure-8-shaped inclined surface.

When the first cover 9 is opened, the components are returned to the original positions thereof in the order reverse to that of the above operating process.

Meanwhile, in the case where the drive lever 12 is removed from the first cover 9, when the first cover 9 is closed, the rotating body 6 is not rotated. Therefore, the optical fiber F is cleaved in a direction perpendicular to the axis thereof. Furthermore, the optical fiber cleaver may be used without having the clamping block 14, that is, without clamping the optical fiber in the double clamping manner.

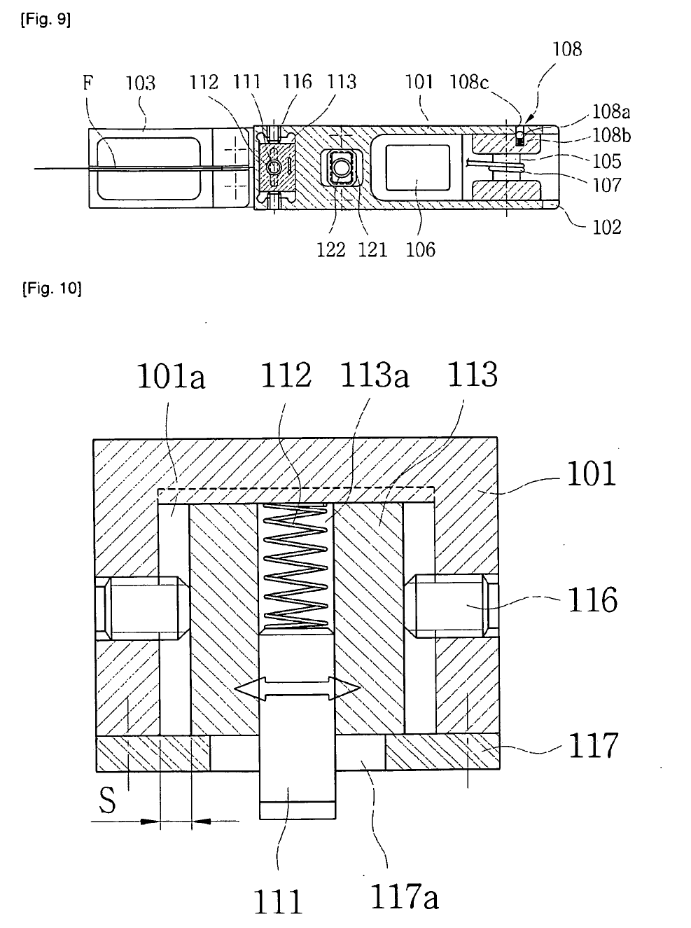

FIGS. 8 through 12 illustrate an optical fiber cleaver according to a second embodiment of the present invention. The optical fiber cleaver according to the second embodiment includes a cleaving unit 100 having a linear blade 111.

In detail, as shown in the drawings, the cleaving unit 100 according to the second embodiment includes a base 102, a cover 101, which is pivotably provided on the base 102, an elastic support member 107, which elastically supports the cover 101, the linear blade 111, which is provided in an end of the cover 101, a clamping block 121, which is provided under the lower surface of the cover 101, and a support 103, which is coupled to the base 102 through a bendable connection member 104.

The cover 101 is provided on the base 102 so as to be pivotable using a hinge shaft 105. The elastic support member 107, such as a torsion spring, is fitted over the hinge shaft 105, and elastically supports the cover 101 with respect to the base 102 on the hinge shaft 105.

Furthermore, a position maintaining unit 108, which maintains a rotated position of the cover 101 relative to the base 102, is provided between the cover 101 and the base 102. The position maintaining unit 108 includes a ball 108a, which is selectively and removably inserted into at least one hole 108c formed in one selected from the cover 101 and the base 102, and an elastic member 108b, which elastically supports the ball 108a. Thus, when the ball 108a is inserted into one hole 108c, the cover 101 can maintain a state in which it is rotated at a predetermined angle relative to the base 102. When an external force that overcomes the elastic force of the elastic member 108b is applied to the cover 101, the cover 101 enters a rotatable state.

The linear blade 111 is provided on the free end of the cover 101. As shown in FIGS. 8 through 10, the free end of the cover 101 has a space 101a therein. A mounting block 113 is installed in the space 101a. The mounting block 113 has a mounting space 113a therein. The linear blade 111 is provided in the mounting space 113a such that the linear blade 111 is elastically supported by the elastic support member 112.

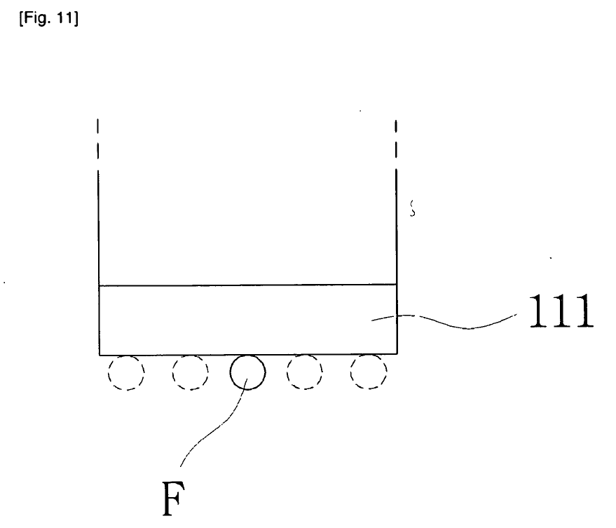

The mounting block 113 has a width less than the inner width of the space 101a, such that the mounting block 113 is movable in the space 101a in a direction perpendicular to the axis of the optical fiber F. In detail, as shown in FIG. 10, a gap S is defined between the mounting block 113 and each of the opposite inner surfaces of the space 101a. The distances of the gaps S can be adjusted by left and right adjustment screws 116. Thereby, the position of the linear blade 111 is adjustable in a direction perpendicular to the axis of the optical fiber F. That is, in the second embodiment, because the position of the linear blade 111 is adjustable in a direction perpendicular to the axis of the optical fiber F, as shown in FIG. 11, the entire edge of the linear blade 111 can be evenly used, so that the lifetime of the linear blade 111 can be extended.

Furthermore, a guide protrusion 114 and a guide slot 115, which correspond to each other, are provided between the mounting block 113 and the space 101a. Thereby, movement of the mounting block 113 can be stably conducted.

In addition, a support bracket 117 is provided under the space 101a. The support bracket 117 has a hole 117a, through which the linear blade 111 passes.

The clamping block 121 is provided under the lower surface of the cover 102 such that the clamping block 121 is elastically supported by an elastic support member 122. Thus, when the cover 101 is closed, the clamping block 121 elastically compresses the upper surface of the optical fiber F, so that the optical fiber F can be clamped more reliably.

The support 103 is coupled to the base 102 through the connection member 104. The connection member 4 is made of bendable material and thus connects the support 103 to the base 102 such that the support 103 is foldable onto the base 102.

Furthermore, a stripper 106 is provided on one surface selected from the base 102 or the cover 101. The stripper 106 may have various structures such that it can strip sheathing from the optical fiber F.

The operation of the optical fiber cleaver according to the second embodiment of the present invention will be described herein below.

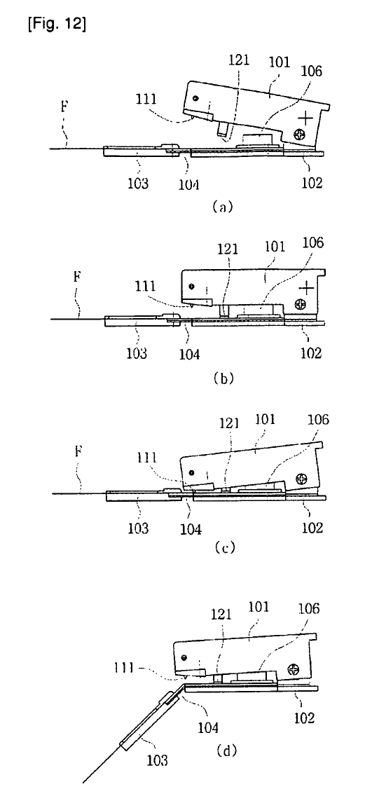

First, as shown in FIG. 12a, the sheathing is removed from the optical fiber F by passing the optical fiber F through the stripper 106 of the cleaving unit 100.

Thereafter, as shown in FIG. 12b, the cover 101 of the cleaving unit 100 is pivoted to close onto the base 102. Then, the clamping block 121 compresses part of the optical fiber F and clamps it.

Subsequently, as shown in FIGS. 12c, the cover 101 is pivoted further onto the base 102. Then, the cover 101 and the base 102 come into complete contact with each other, and the linear blade 111 thus scores the optical fiber F.

Finally, as shown in FIG. 12d, the support 103 is bent on the bendable connection member 104 with respect to the base. As a result, the scored optical fiber F is cleaved.

The general construction, such as the twisting unit 2, the tension unit 40, and so on, of the optical fiber cleaver according to the second embodiment, other than the above-mentioned structure, is equal to or similar to that of the first embodiment, therefore further explanation is deemed unnecessary.

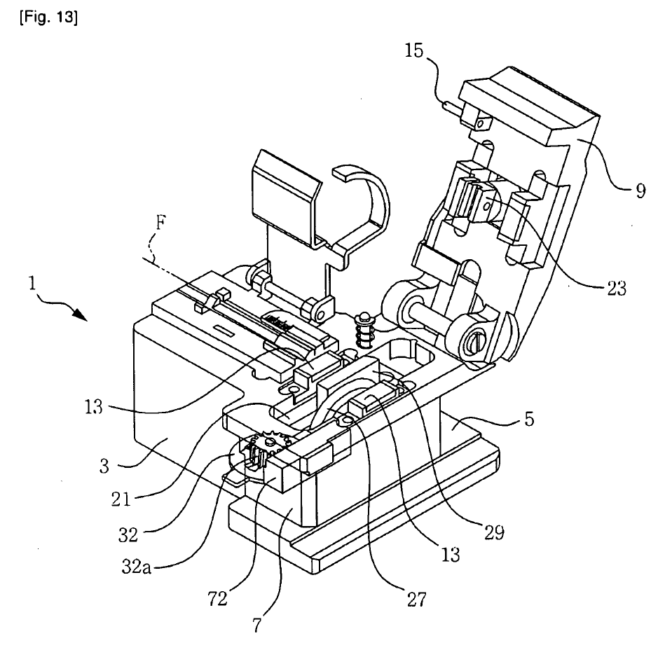

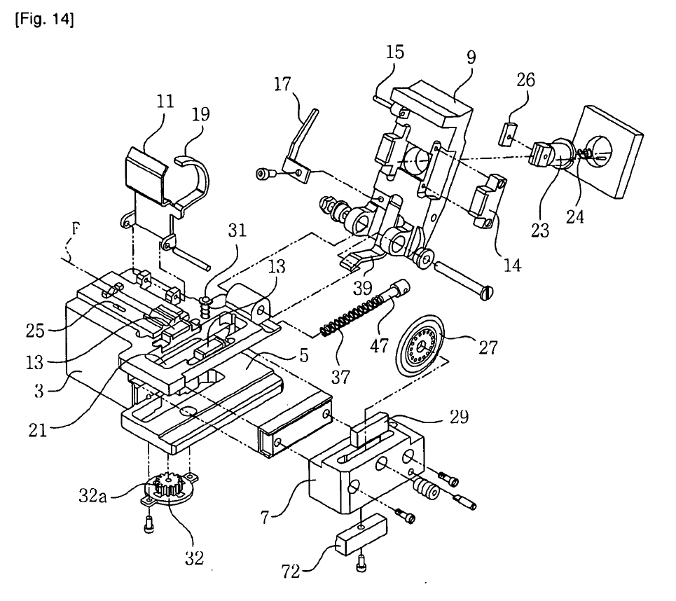

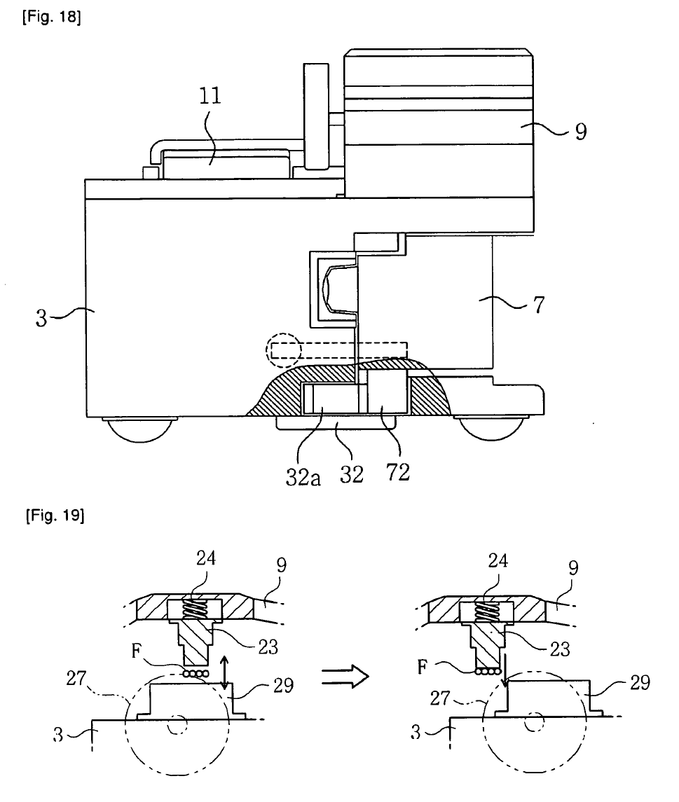

FIGS. 13 through 19 illustrate an optical fiber cleaver according to a third embodiment of the present invention. The optical fiber cleaver according to the third embodiment of the present invention is characterized in that, when a striking member 23 and a stop protrusion 29 of a slider 7 are disposed adjacent to each other, a repulsive force is generated therebetween.

The striking member 23 is elastically supported by a spring 24 such that it can elastically move and strike the optical fiber F.

Here, the striking member 23 may be made of magnetic material. Alternatively, the striking member 23 may have at a predetermined position thereof a separate stopper 26, which is made of magnetic material. Furthermore, the stop protrusion 29 of the slider 7 is made of a magnet, and the stop protrusion 29 and the striking member 23 or the stopper 26 are oriented such that like poles thereof face each other.

Therefore, as shown in FIG. 19, when the striking member 23 and the stop protrusion 29 are disposed adjacent to each other, the striking member 23 is moved away from the optical fiber F by repulsive force generated between the like poles of the striking member 23 and the stop protrusion 29. When the stop protrusion 29 is moved by the movement of the slider 7 and thus becomes misaligned with the striking member 23, the striking member 23 moves to the optical fiber F and strikes it, thus cleaving the optical fiber F. Here, when the slider 7 is moved, a blade 27 scores the optical fiber F.

Particularly, in the third embodiment of the present invention, the striking member 23 is evenly supported by the repulsive force, generated between the striking member 23 and the stop protrusion 29, which are disposed adjacent to each other, so that the striking member 23 is not biased in one direction. Therefore, the accuracy of the striking operation is increased. Thereby, the optical fiber F can be cleaved more accurately and evenly.

The general construction of the third embodiment, other than the above-mentioned structure, remains the same as the first or second embodiment, therefore further explanation will be omitted.

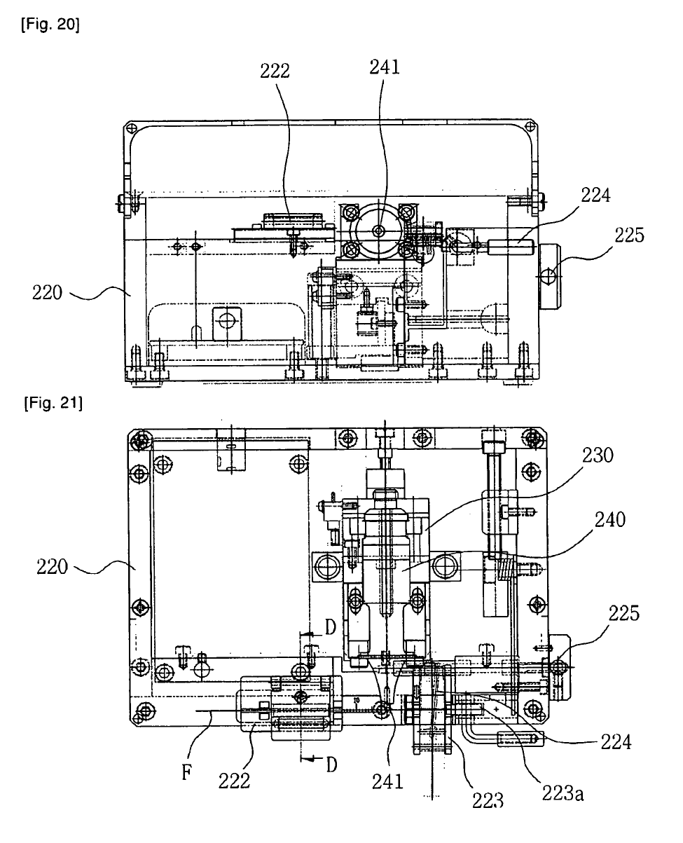

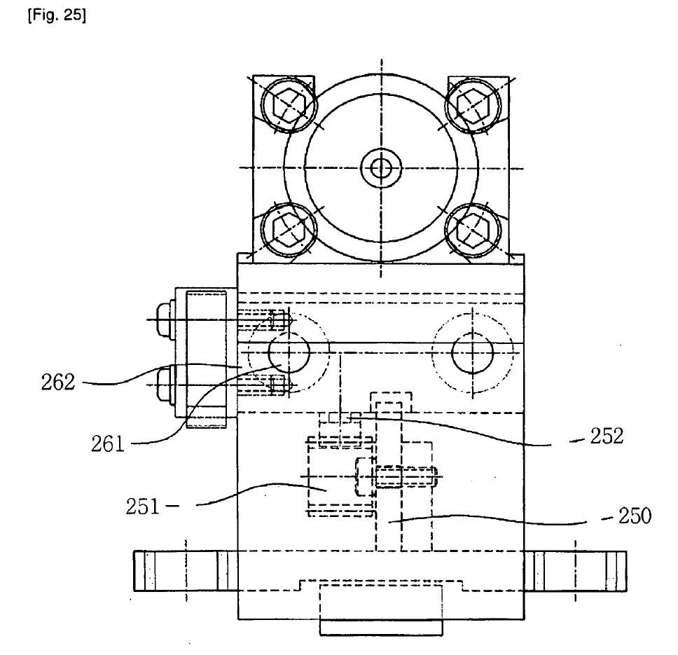

FIGS. 20 through 25 illustrate an optical fiber cleaver according to a fourth embodiment of the present invention. The optical fiber cleaver according to the fourth embodiment is an optical fiber cleaver that uses ultrasonic waves.

As shown in the drawings, the ultrasonic optical fiber cleaver according to the fourth embodiment includes a main body 220, a first clamp 222, which is pivotably provided on the main body 220, a second clamp 223, which is pivotably and rotatably provided on the main body 220, and a tension lever 224, which applies tensioning force to an optical fiber F that is clamped by moving the second clamp 223.

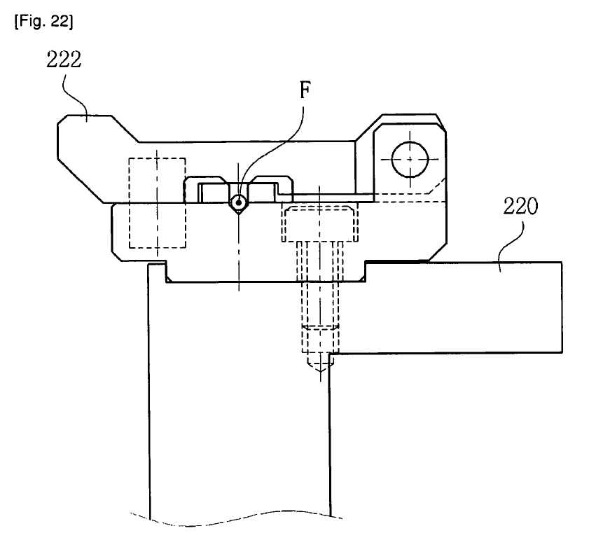

As shown in FIG. 22, the first and second clamps 222 and 223 are pivotably mounted to the main body 200. In particular, the second clamp 223 is provided so as to be movable by the tension lever 224. Thus, tensioning force is applied to the optical fiber F between the first and second clamps 222 and 223.

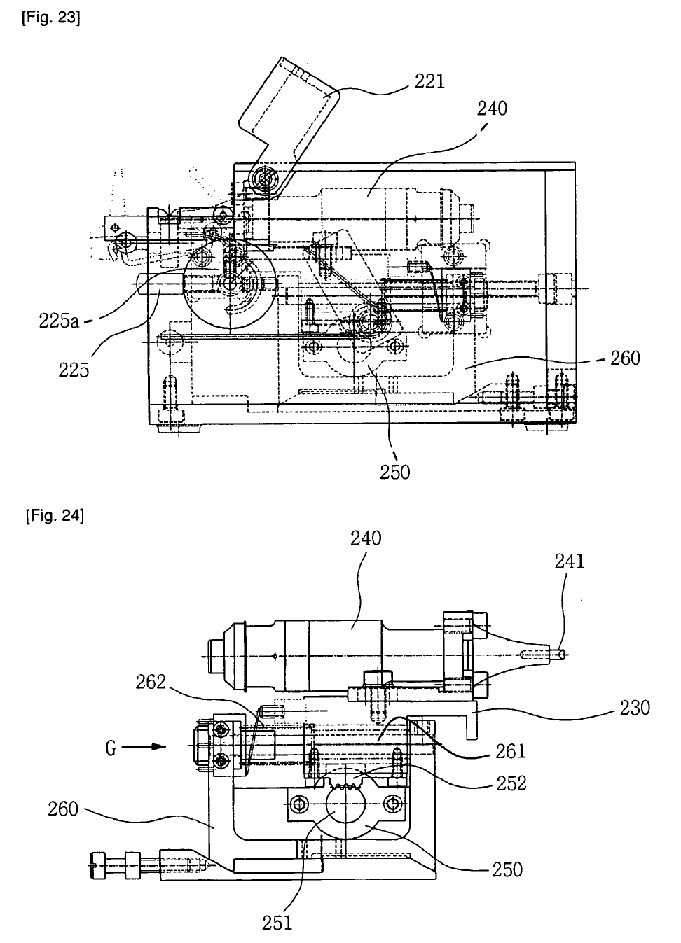

The first and second clamps 222 and 223 are protected by a protective cover 221, shown in FIG. 23, at set positions thereof.

The main body 220 has a U-shaped support bracket 260 therein. A guide rod 261 is provided in the support bracket 260. A slider 230 is moved along the circumferential outer surface of the guide rod 261. Furthermore, biasing force is applied from a biasing member 262 to the slider 230 in one direction.

The slider 230 is provided so as that it can be brought into contact with and separated from a cam 225a provided on an operation lever 225. Thus, the slider 230 is supported by the cam 225a upon rotation of the operation lever 225 or is moved by the biasing member 262. In detail, while the slider 230 is supported on the cam 225a of the operation lever 225, when the operation lever 225 is rotated, the slider 230 is moved away from the cam 225a. Then, the slider 230 is moved in one direction by the biasing force applied thereto from the biasing member 262.

Furthermore, an ultrasonic wave generating device 240 is fastened to the slider 230. The ultrasonic wave generating device 240 has an ultrasonic blade 241 on an end thereof. The ultrasonic blade 241 cleaves the optical fiber F using ultrasonic waves.

In addition, the ultrasonic optical fiber cleaver according to the fourth embodiment is provided with a damper 250 for maintaining the speed, at which the slider 230 is moved, constant. Various kinds of dampers, for example, a rotary damper, using damping force generated by the viscous resistance of oil, or an oscillating damper, using oil pressure, can be used as the damper 250. The slider 230 can maintain a constant moving speed using the damper 250.

1. An optical fiber cleaver for twisting and cleaving an optical fiber at a predetermined angle, wherein a tensioning force is applied to or removed from the optical fiber by closing or opening a cover provided in a cleaving unit.

2. An optical fiber cleaver for twisting and cleaving an optical fiber at a predetermined angle, wherein a twisting force is applied to or removed from the optical fiber by closing or opening a cover provided in a cleaving unit.

3. An optical fiber cleaver for twisting and cleaving an optical fiber at a predetermined angle, wherein a tensioning force is applied to or removed from the optical fiber and a twisting force is applied to or removed from the optical fiber by closing or opening a cover provided in a cleaving unit.

4. An optical fiber cleaver for twisting and cleaving an optical fiber at a predetermined angle, wherein a tensioning force and a twisting force are applied to the optical fiber by closing a cover, provided in a cleaving unit, such that the optical fiber is cleaved, and the tensioning force and the twisting force are removed from the optical fiber by opening the cover.

5. An optical fiber cleaver for clamping opposite portions of a part of an optical fiber to be cleaved and for scoring and cleaving the optical fiber, wherein a slider scores the optical fiber to cleave the optical fiber by closing a cover provided in a cleaving unit, and the slider is returned to an original position thereof.

6. An optical fiber cleaver for clamping opposite portions of a part of an optical fiber to be cleaved and for scoring and cleaving the optical fiber, wherein one of upper and lower clamping blocks for clamping the optical fiber is stationary, and a remaining one of the upper and lower clamping blocks is provided with an elastic member such that the optical fiber is accurately clamped.

7. An optical fiber cleaver for clamping an optical fiber at positions spaced apart from each other by a predetermined distance and for scoring a medial portion of a clamped portion of the optical fiber using a blade to cleave the optical fiber, wherein the optical fiber is clamped at first clamping positions spaced apart from each other by the predetermined distance, the clamped optical fiber is twisted, opposite portions of a part of the twisted optical fiber to be cleaved are clamped between the first clamping positions by upper and lower clamping blocks, and the optical fiber is scored and angle-cleaved.

8. An optical fiber cleaver for clamping an optical fiber at positions spaced apart from each other by a predetermined distance and for scoring a medial portion of a clamped portion of the optical fiber using a blade to cleave the optical fiber, wherein the optical fiber is clamped at first clamping positions spaced apart from each other by the predetermined distance, and, when a cover provided in a cleaving unit is closed, the clamped optical fiber is twisted, opposite portions of a part of the twisted optical fiber to be cleaved are clamped between the first clamping positions by upper and lower clamping blocks, and the optical fiber is scored and angle-cleaved.

9. An optical fiber cleaver for clamping an optical fiber at positions spaced apart from each other by a predetermined distance and for scoring a medial portion of a clamped portion of the optical fiber using a blade to cleave the optical fiber, wherein the optical fiber is-clamped-at first clamping positions spaced apart from each other by the predetermined distance, and, when a cover provided in a cleaving unit is closed, the clamped optical fiber is twisted by rotation of a rotating body, opposite portions of a part of the twisted optical fiber to be cleaved are clamped between the first clamping positions, and the optical fiber is scored and angle-cleaved.

10. An optical fiber cleaver for clamping an optical fiber at positions spaced apart from each other by a predetermined distance and for scoring a medial portion of a clamped portion of the optical fiber using a blade to cleave the optical fiber, wherein the optical fiber is clamped at the opposite positions spaced apart from each other by the predetermined distance, a twisting force and a tensioning force are applied to the clamped optical fiber, and the optical fiber is scored and angle-cleaved.

11. An optical fiber cleaver for clamping an optical fiber at positions spaced apart from each other by a predetermined distance and for scoring a medial portion of a clamped portion of the optical fiber using a blade to cleave the optical fiber, wherein the optical fiber is clamped at the opposite positions spaced apart from each other by the predetermined distance, a twisting force is applied to the clamped optical fiber, and, when a cover provided in a cleaving unit is closed, the optical fiber is scored and angle-cleaved.

12. An optical fiber cleaver for clamping an optical fiber at positions spaced apart from each other by a predetermined distance and for scoring a medial portion of a clamped portion of the optical fiber using a blade to cleave the optical fiber, wherein the optical fiber is clamped at the opposite positions spaced apart from each other by the predetermined distance, and, when a cover provided in a cleaving unit is closed, a twisting force is applied to the clamped optical fiber, and the optical fiber is scored and angle-cleaved.

13. An optical fiber cleaver for clamping an optical fiber at positions spaced apart from each other by a predetermined distance and for scoring a medial portion of a clamped portion of the optical fiber using a blade to cleave the optical fiber, wherein the optical fiber is clamped at the opposite positions spaced apart from each other by the predetermined distance, and a twisting force and a tensioning force are applied to the clamped optical fiber and the optical fiber is scored and angle-cleaved by opening and closing a cover provided in a cleaving unit.

14. An optical fiber cleaver for clamping an optical fiber at positions spaced apart from each other by a predetermined distance and for scoring a medial portion of a clamped portion of the optical fiber using a blade to cleave the optical fiber, wherein the optical fiber is clamped at first clamping positions spaced apart from each other by the predetermined distance, and, when a cover provided in a cleaving unit is closed, the optical fiber is twisted by rotation of a rotating body, and, simultaneously, the optical fiber is tensioned by movement of a tension unit, and opposite portions of a part of the twisted and tensioned optical fiber to be cleaved are clamped between the first clamping positions before the optical fiber is scored and angle-cleaved.

15. An optical fiber cleaver for scoring an optical fiber using a linear blade and for cleaving the optical fiber by bending the scored portion of the optical fiber, wherein the linear blade is provided so as to be movable in a direction per-pendicular to an axis of the optical fiber.

16. An optical fiber cleaver for scoring an optical fiber using a linear blade and for cleaving the optical fiber by bending the scored portion of the optical fiber, wherein a stripping blade is provided in a main body, so that both an operation of stripping the optical fiber and the operation of cleaving the optical fiber are conducted.

17. An optical fiber cleaver for scoring an optical fiber using a blade, provided in a slider, by moving the slider using an elastic force of an elastic member, the optical fiber cleaver comprising a damper damping a speed at which the slider is moved by the elastic force of the elastic member, such that the slider is moved at a speed close to a constant speed.

18. An optical fiber cleaver for cleaving an optical fiber using an ultrasonic blade, provided in a slider, by moving the slider using elastic force of an elastic member, the optical fiber cleaver comprising a damper damping a speed at which the slider is moved by the elastic force of the elastic member, such that the slider is moved at a speed close to a constant speed.

19. An optical fiber cleaver for scoring an optical fiber by moving a blade provided in a slider and for cleaving the optical fiber by striking the scored portion of the optical fiber, wherein a striking member for striking the optical fiber is supported using a repulsive force between same poles of magnets, and, when the support of the striking member using the repulsive force between like poles of the magnets is released, the striking member strikes the scored portion of the optical fiber, thus cleaving the optical fiber.

20. The optical fiber cleaver according to claim 17, wherein the blade is made of synthetic diamond.

21. The optical fiber cleaver according to claim 17, wherein the blade has a pointed edge, and a reinforcing layer is formed on the pointed edge.
